(19) United States
(12) Patent Application Publication
(10) Pub. No.: US 2021/0320817 A1
(43) Pub. Date: Oct. 14, 2021

(54) VIRTUAL ROUTING AND FORWARDING SEGREGATION AND LOAD BALANCING IN NETWORKS WITH TRANSIT GATEWAYS

(71) Applicant: Cisco Technology, Inc., San Jose, CA (US)

(72) Inventors: Rajagopalan Janakiraman, Cupertino, CA (US); Sivakumar Ganapathy, Fremont, CA (US); Shashank Chaturvedi, San Jose, CA (US); Suresh Pasupula, Cupertino, CA (US); Prashanth Matety, Fremont, CA (US); Sachin Gupta, Santa Clara, CA (US)

(21) Appl. No.: 16/848,647

(22) Filed: Apr. 14, 2020

(51) Int. Cl. H04L 12/46; H04L 29/08; H04L 29/12

(52) U.S. Cl. CPC H04L 12/4633; H04L 61/2582; H04L 69/324; H04L 12/4641

(57) ABSTRACT

Techniques and architecture for routing data packets through networks that include TGWs. A data packet may be received from a TGW at an infra VPC. A TGW attachment on which the data packet was received is determined. Based at least in part on the TGW attachment, the data packet is routed to a CSR at the infra VPC. Load balancing may be achieved by defining VRF groups that include VPCs and the TGWs. Each VRF group may be assigned to an interface of one or more CSRs. Also, the VRF groups allow for supporting overlapping subnets.

### TECHNICAL FIELD

The present disclosure relates generally to virtual routing and forwarding (VRF) segregation and load balancing in cloud networks that include transit gateways (TGWs).

### BACKGROUND

With the continued increase in the proliferation and use of devices with Internet accessibility, the demand for Internet services and content has similarly continued to increase. The providers of the Internet services and content continue to scale the computing resources required to service the growing number of user requests without falling short of user-performance expectations. For instance, providers typically utilize large and complex datacenters to manage the network and content demands from users. The datacenters generally comprise server farms that host workloads that support the services and content, and further include network devices such as switches and routers to route traffic through the datacenters and enforce security policies.

Generally, these networks of datacenters can come in two flavors: private networks owned by entities such as enterprises or organizations (e.g., on-premises networks), and public cloud networks owned by cloud providers that offer compute resources for purchase by users. Often, enterprises will own, maintain, and operate on-premises networks of compute resources to provide Internet services and/or content for users or customers. However, as noted above, it can become difficult to satisfy the increasing demands for computing resources while maintaining acceptable performance for users. Accordingly, private entities often purchase or otherwise subscribe for use of compute resources and services from public cloud providers. For example, cloud providers can create virtual private clouds (also referred to herein as “private virtual networks”) on the public cloud and connect the virtual private cloud or network to the on-premises network in order to grow the available compute resources and capabilities of the enterprise. Thus, enterprises can interconnect their private or on-premises network of datacenters with a remote, cloud-based datacenter hosted on a public cloud, and thereby extend their private network.

However, because on-premises networks and public cloud networks are generally developed and maintained by different entities, there is a lack of uniformity in the policy management and configuration parameters between the datacenters in the on-premises networks and public cloud networks. This lack of uniformity can significantly limit an enterprise's ability to integrate their on-premises networks with public cloud networks by, for example, being unable to apply consistent policies, configuration parameters, routing models, and so forth. Various entities have developed software-defined network (SDN) and datacenter management solutions that translate the intents of enterprise or organizations from their on-premises networks into their virtual private cloud networks for applications or services that are deployed across multi-cloud fabrics or environments. Accordingly, these multi-cloud SDN solutions must continually adapt for changes occurring within the on-premises networks and public cloud networks, while maintaining the business and user intents of the enterprises or organizations that supplement their on-premises networks with computing resources from the public cloud networks.

For example, enterprises that manage on-premises networks of datacenters often isolate and segment their on-premises networks to improve scalability, resiliency, and security in their on-premises networks. To satisfy the entities' desire for isolation and segmentation, the endpoints in the on-premises networks can be grouped into endpoint groupings (EPGs) using, for example, isolated virtual networks that can be used to containerize the endpoints to allow for applying individualized routing models, policy models, etc., across the endpoints in the EPGs. Generally, each subnet in an EPG or other virtual grouping of endpoints is associated with a range of addresses that can be defined in routing tables used to control the routing for the subnet. Due to the large number of routing tables implemented to route traffic through the on-premises networks, the entities managing the on-premises networks utilize virtual routing and forwarding (VRF) technology such that multiple instances of a VRF routing table are able to exist in a router and work simultaneously. Accordingly, subnets of EPGs in the on-premises networks of entities are associated with respective VRF routing tables and routers are able to store and utilize multiple instances of VRF routing tables simultaneously.

While SDN solutions may implement VRF segregation for traffic in the on-premises networks, various issues may arise when maintaining the VRF segregation for all traffic going between the public cloud network and the on-premises network. Generally, public cloud networks may include multiple regions, sites, or other areas where a VRF may be mapped into one VPC per region. Across the VRFs in the public cloud network, subnets can overlap in various examples, such as subnets overlapping between different VPCs in a same region, or across different regions if the VPCs belong to different VRFs. Overlapping subnets across VPCs and regions is often necessary for a multi-cloud fabric solution due to the VRFs needing to remain the same between on-premises datacenters and cloud datacenters such that the workloads can extend between the two domains seamlessly and carry overlapping Internet Protocol (IP) addresses with end-to-end segmentation and isolation.

Networks that include transit gateways (TGWs), e.g., networks provided by Amazon Web Services (AWS), provide high bandwidth inter-VPC connectivity within a region. VPCs connect to the TGW via a TGW attachment (also known as a VPC attachment), which generally has high bandwidth, e.g., up to 50 gigabits per second. Note that the terms “transit gateway attachment” and “VPC attachment” may be used interchangeably herein. Network architectures utilizing TGWs and virtual private network (VPN) attachments are known. However, such architectures may have certain limitations. For example, there may be a limitation of 100 border gateway protocol (BGP) routes on the VPN attachments. Additionally, the VPN based architecture may have a limit of 1.25 gigabits (Gb) per second (or less) per VPN connection. Generally, if the network supports n-way equal-cost multi-path (ECMP) routing, where n is equal to, for example, 8, this means that a maximum bandwidth of 12 Gb per second per TGW is provided (8×1.25 Gb). Additionally, in such an architecture, VRF segregation may be lost the moment a data packet enters a TGW, e.g., routes across all VRFs coming from CSRs may get propagated to all route tables in the TGW. This is generally a large waste of resources. Also, the routes within the architecture, when propagated to user VPCs, may fill up smaller route tables in the VPCs fairly quickly. Additionally, most of the routes may belong to different VRFs, thereby causing every VPC to see routes from all other VPCs, which is a clear violation of VRF segregation.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIGS. 1A-1E schematically illustrate example arrangements of portions and components of a site of a region of a cloud network including TGWs.

FIG. 2 illustrates a flow diagram of an example method for routing data packets through the example arrangements of FIGS. 1A-1E.

FIG. 3 illustrates a computing system diagram illustrating a configuration for a datacenter that can be utilized to implement aspects of the technologies disclosed herein.

FIG. 4 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes a method for routing data packets through networks that include transit gateways (TGWs). The method may include receiving a data packet from a TGW at an infra virtual private cloud (VPC). The method may also include determining a TGW attachment on which the data packet was received. Additionally, the method may further include based at least in part on the TGW attachment, routing the data packet to a cloud service router (CSR) at the infra VPC.

Additionally, the method may include based at least in part on the TGW attachment, determining an interface of the CSR to which to route the data packet and routing the data packet to the interface of the CSR. Also, in configurations (i) the data packet may be a first data packet, (ii) the TGW may be a first TGW, and (iii) the TGW attachment may be a first TGW attachment, with the method further including receiving a second data packet from a second TGW at the infra VPC, determining a second TGW attachment on which the second data packet was received, and based at least in part on the second TGW attachment, routing the second data packet to the CSR at the infra VPC. Furthermore, in configurations, the interface may be a first interface, with the method further including based at least in part on the second TGW attachment, determining a second interface of the CSR to which to route the second data packet, and routing the second data packet to the second interface of the CSR.

Additionally, the techniques described herein may be performed by a system and/or device having non-transitory computer-readable media storing computer-executable instructions that, when executed by one or more processors, performs the method described above.

### EXAMPLE EMBODIMENTS

As noted above, enterprises and other organizations may own, maintain, and operate on-premises networks of computing resources for users or customers, and also for supporting internal computing requirements for running their organizations. However, due to the difficulties in satisfying the increasing demands for computing resources while maintaining acceptable performance for users, these enterprises may otherwise subscribe for use of computing resources and services from public cloud providers. For example, cloud providers can create virtual private clouds (also referred to herein as “private virtual networks”) on the public cloud and connect the virtual private cloud or network to the on-premises network in order to grow the available computing resources and capabilities of the enterprise. Thus, enterprises can interconnect their private or on-premises network of datacenters with a remote, cloud-based datacenter hosted on a public cloud, and thereby extend their private network.

However, the lack of uniformity between on-premises networks and public cloud networks across various dimensions, such as policy management, configuration parameters, etc., may significantly limit an enterprise's ability to integrate their on-premises networks with public cloud networks by, for example, being unable to apply consistent policies, configuration parameters, routing models, and so forth. Various SDN solutions have been developed to translate the intents of enterprises or organizations from their on-premises networks into their virtual private cloud networks for applications or services that are deployed across multi-cloud fabrics or environments. For example, Cisco's software-defined network and datacenter management solution, the Application-Centric Infrastructure (ACI), provides a comprehensive solution for automated network connectivity, consistent policy management, and simplified operations for multi-cloud environments. The Cisco Cloud ACI solution allows enterprises to extend their on-premises networks into various public clouds, such as Amazon Web Services (AWS), Google Cloud, Microsoft Azure, and so forth. The Cisco Cloud ACI solution provides an architectural approach for interconnecting and managing multiple regions and/or sites, such as by defining inter-cloud policies, providing a scalable architecture with full fault-domain isolation and change-domain isolation, and ensuring that issues cannot cascade and bring down the entire distributed environment.

Various difficulties arise for SDN solutions such as Cisco Cloud ACI when attempting to interconnect on-premises networks of datacenters with public cloud networks of datacenters. For example, cloud providers may impose different restrictions on networking configurations and policies, routing and policy models, and/or other restrictions for their public clouds. These restrictions may be different than the restrictions or permissions implemented by enterprises who have developed their on-premises networks of datacenters. However, to interconnect on-premises networks with public cloud networks, SDN solutions in the multi-cloud fabric space often have to reconcile those differences to seamlessly scale the on-premises networks across the public cloud networks.

As an example, VPCs (virtual private clouds in AWS) in a public cloud network generally need to connect to routers in order to route traffic between the endpoints in the VPCs of the public cloud network and endpoints or other devices in the on-premises network. SDN solutions attempt to automate this connectivity between the on-premises networks and public cloud networks, such as by using solutions offered by providers of the public cloud networks. As an example, AWS provides a Transit Gateway (TGW) for use in automating this connectivity. Generally, the TGW, or just gateway, comprises a distributed router that connects to multiple VPCs. Rather than establishing VPN connections from each VPC to the router, the gateway is able to connect multiple VPCs to a single gateway, and also their on-premises networks to the single gateway. Attaching VPNs to each VPC is a cumbersome and costly task, and the transit gateway provides a single connection from on-premises networks to reach multiple VPCs in the AWS public cloud with relatively high bandwidth compared to VPN connections.

While these gateways are advantageous for various reasons, the different restrictions imposed for using these gateways surface issues for SDN controllers to solve when automating interconnectivity across a multi-cloud fabric. As an example, the gateways may require that each VPC connected to a particular gateway does not have overlapping subnets. Stated otherwise, all of the VPCs connected to a given gateway may be required to have unique address spaces or ranges (e.g., classless inter-domain routing (CIDR) blocks) that do not overlap. However, enterprises that manage on-premises networks often define address ranges, such as VRFs, that have overlapping address spaces (e.g., overlapping prefixes). In fact, that is one of the advantages of VRFs is to allow for overlapping subnets while providing segmentation and isolation for network paths.

One of the infrastructure blocks in a cloud networking/transit solution, e.g., Cisco Cloud ACI, is a cloud router (CSR) that performs fine-grained routing between VPCs, or between VPCs and an on-premises network.

In configurations, a distributed cloud router may be provided for use as the networking block that connects source VPCs and destination VPCs of a data packet, as well as services provided within VPCs, e.g., a service chain between the source VPC and the destination VPC. The distributed cloud router may span multiple regions of public cloud networks and may be across multiple public cloud networks (e.g., AWS cloud networks and Microsoft Azure public cloud networks). Each instance of the cloud router may run or operate within one infra VPC within a region.

ACI anywhere may provide VRF level segmentation within a multi-cloud fabric and across to various sites. All the sites may be part of an on-premises network, or some sites may be part of an on-premises network while other sites are part of a cloud-based network. Additionally, all the sites may be entirely in the cloud. Moreover, a cloud site may span multiple regions. While some network architectures do not support VRF segregation, some network architectures rely, as previously noted, on VPN attachment between TGWs and infra VPCs, which, as previously noted, has its own bandwidth limitation and needs BGP to support VRF level segmentation. Though BGP provides ECMP using tunnels, the route-scale limits may be too low (e.g., 100 routes per TGW). Thus, utilizing BGP in a network that includes TGWs may be unduly limiting.

In configurations, a VRF group represents a group of VRFs that do not have any overlapping subnets. Although, in configurations, subnets are not allowed to overlap between any two VRFs in the same VRF group, subnets may definitely overlap between VRFs that are in different VRF groups. This technique allows VRFs with overlapping subnets to coexist via different VRF groups. However, in some configurations, VRFs may only talk, e.g., leak routes, to other VRFs within the same VRF group.

A VRF group may be realized in a cloud site by deploying one or more TGWs per region. In configurations, each TGW may belong to exactly one VRF group. In configurations, the VPCs belonging to a given VRF group may be attached to any TGW belonging to that VRF group as long as both the VPC and the TGW are in the same region. VPCs/VRFs within a VRF group are able to freely communicate with each other, while VPCs across VRF groups are prohibited from communicating with each other. Thus, VRF groups allow for support of overlapping subnets even when using TGW and VPC attachments as described herein.

In configurations, an infra VPC, where CSRs are located, is attached to all the TGWs in a region. This means that there are n-infra VPC-TGW attachments, where n is the number of TGWs in that region. The infra VPC may have multiple CSRs for redundancy and load balancing, as will be further described herein.

The infra VPC may be associated to one route table in each TGW, which may be referred to as an infra-route table herein. Routes from all other user VPC route tables are propagated in the TGW into the infra-route table.

In order to load balance traffic originating from different TGWs into different CSRs, an ingress route table is created in the infra VPC for each TGW in that region. The ingress route table may be used to redirect data packets coming from a TGW into one of the m CSRs in the infra VPC. Thus, in configurations, there is one ingress route table per TGW created in the infra VPC. The infra VPC may have, two CSRs, e.g., m=2. The ingress route table for each TGW helps ensure that data packets from a first TGW are routed to a first CSR, while data packets from a second TGW are routed to a second CSR. This helps achieve load balancing.

As previously noted, in configurations ACI VRFs may be segregated into different VRF groups, with overlapping subnets supported across different VRF groups. Thus, in configurations, there may be two VPCs (across two different VRF groups) having the same source subnet. Data packets entering the CSR may thus be identified as belonging to the correct VRF depending on which TGW the packet came from and the source IP/subnet of the data packet.

In configurations, in order to identify this VRF of the data packet, a CSR interface is associated to a unique VRF group, e.g., data packets entering a given interface of a CSR can only come from TGWs belonging to that VRF group. A policy-based routing (PBR) rule is installed on the CSR's network interface (for example, gig two) with the IP based match rule to identify the VRF of the data packet within that VRF group. For example, assume that VRF 1 belongs to VRF group 1, and VRF 2 belongs to VRF group 2, and both of the VRFs contain overlapping subnet 10.0.0.0/16. Also assume that gig 1 interface of the CSR is picked for VRF group 1 and gig 2 interface of the CSR is picked for VRF group 2. Thus, two VRF entries in the CSR need to be provided to dynamically map 10.0.0.0/16 subnet into VRF 1 or VRF 2 based on the ingress interface at the CSR, thereby supporting overlapping subnets by placing VRF 1 and VRF 2 in different VRF groups.

In configurations, redundancy and load balancing may be achieved within a VRF group without the need for BGP and ECMP. Without data path ECMP, a manner in which to load balance traffic to and from the VPCs (via the CSRs for external connectivity) is needed. In one configuration, source-based spraying may be used. Such source-based spraying may provide that traffic originating from different VPCs be routed to different CFRs. However, all traffic from a given VPC may always be pinned to a single CSR (via TGW) and hence may never hit any other CSR. When the VPCs are created, the VPCs are attached to one of the TGWs in their VRF group in their region based on a round robin fashion. This allows the traffic to be load balanced across TGWs in that region. In configurations, each TGW is also mapped to a CSR virtual machine (VM) instance in the infra VPC via a TGW attachment. For every TGW attached to the infra VPC, there is an ingress route table entry that forwards all the traffic received from that TGW to a particular interface on the CSR. Thus, such technique translates to each VRF group being mapped to exactly one interface on each CSR in that region. As VRF groups are added, another interface on the CSR may be provisioned to receive traffic from the VPCs in that VRF group. Consequently, the number of gig interfaces on the CSRs determines the number of VRF groups that the architecture may support. To scale beyond the number of VRF groups, it may be desirable to deploy more CSR interfaces or create new CSRs to support newer VRF groups. If a CSR were to go down, just by changing the ingress subnets route table entry for the TGW attachment in the infra VPC, the traffic may be routed to an interface on another CSR, thereby minimizing traffic loss.

In another configuration, destination-based spraying may be utilized where a given VPC attaches to two different TGWs. Each TGW in the pair may be mapped to different CSRs. Thus, in order to spray the traffic between the two CSRs, the traffic out of the VPC needs to be load balanced across the two TGWs to which the particular VPC is attached. This may be achieved by using the egress route table in the VPC to redirect the traffic to TGW1 or TGW2 based on the destination, e.g., destination-based load balancing.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

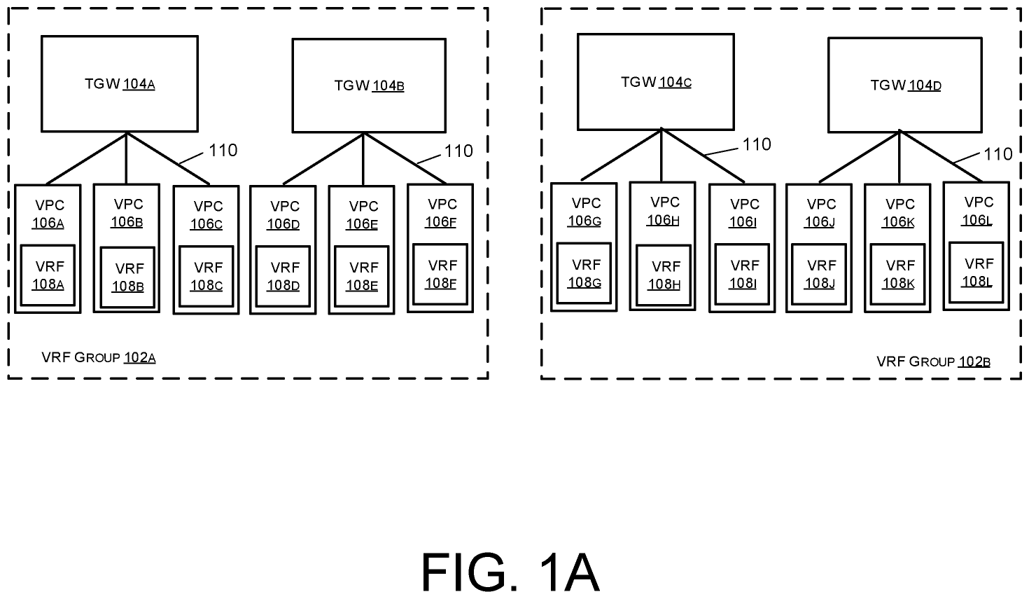

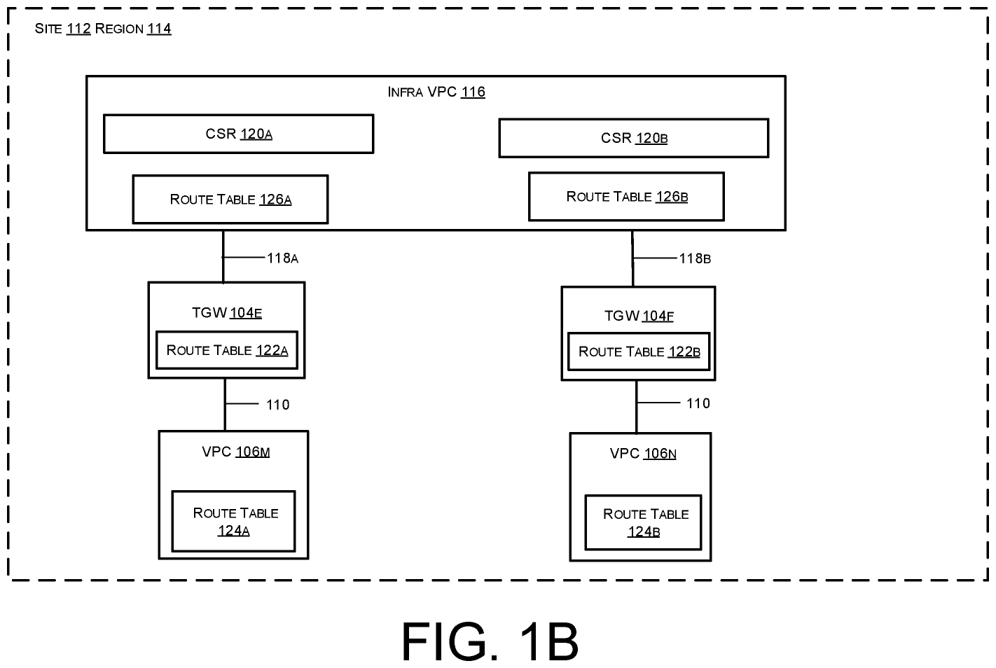

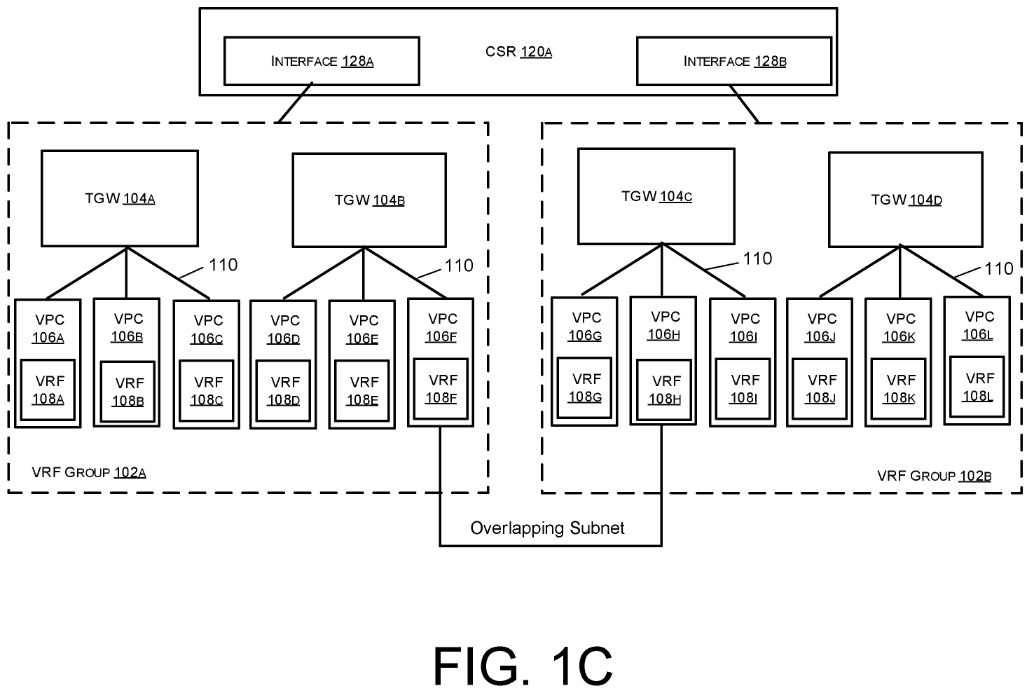

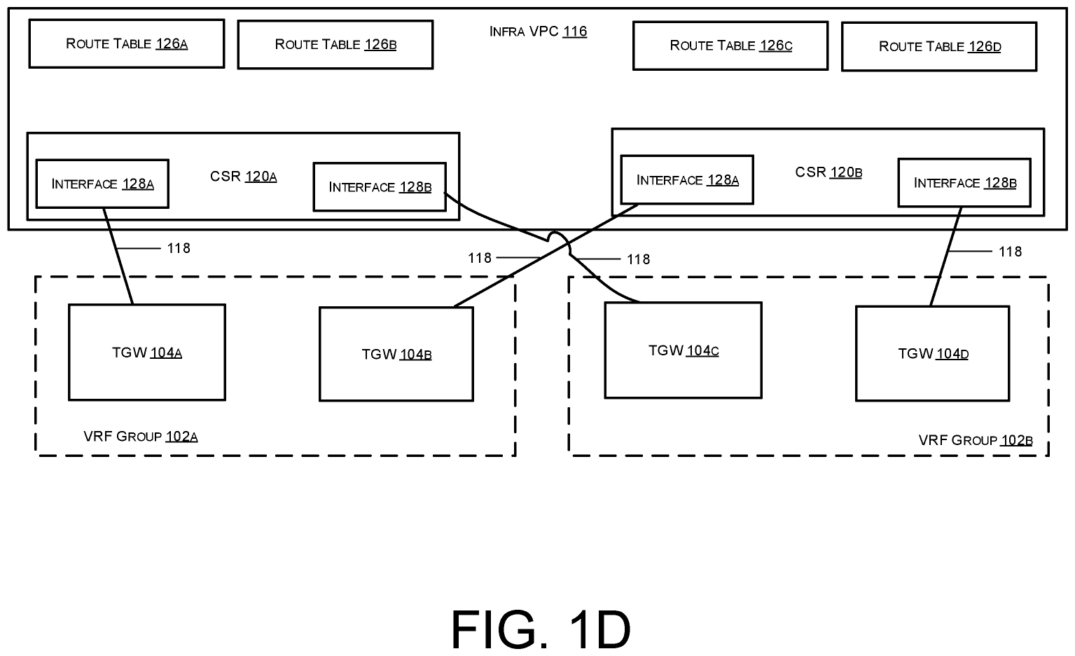

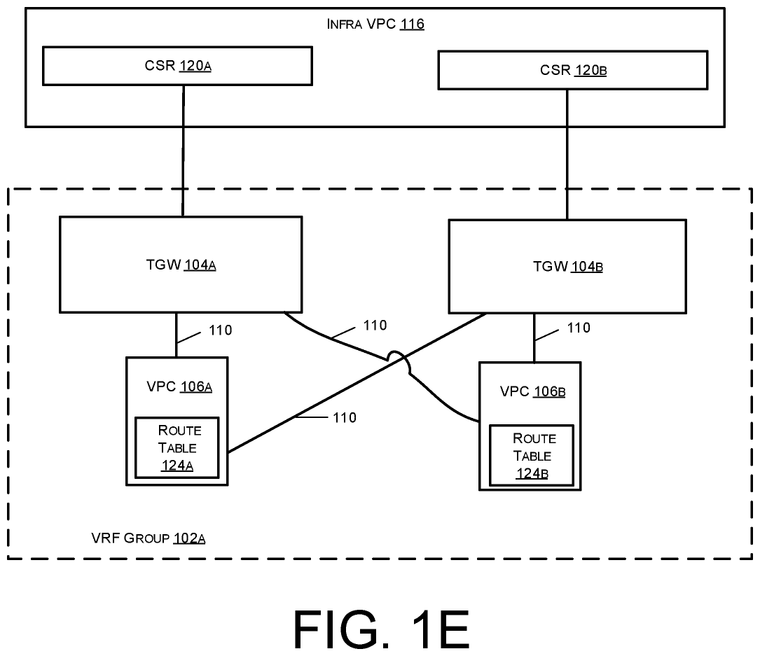

FIG. 1A schematically illustrates an example of two VRF groups 102a and 102b. VRF groups may be referred to generally herein as VRF group(s) 102. VRF group 102a includes two TGWs 104a and 104b, while VRF group 102b includes two TGWs 104c and 104d. TGWs may be referred to generally herein as TGW(s) 104. VRF group 102a also includes VPCs (e.g., user VPCs) 106a-106f, while VRF group 102b includes VPCs 106g-1061. VPCs may be referred to generally herein as VPC(s) 106. As may be seen in FIG. 1A, each VPC 106 includes a corresponding VRF 108, e.g., VRFs 108a-108g corresponding to VPCs 106a-g and VRFs-108h-108l corresponding to VPCs 106h-1061. VRFs may be referred to generally herein as VRF(s) 108. In configurations, there may be more VRF groups 102 and each VRF group 102 may have on a single TGW 104 or may have more than two TGWs 104. Additionally, each VRF group 102 may have more or fewer than six VPCs 106 and corresponding VRFs 108. The VPCs 106 are attached to the TGWs 104 via TGW attachments 110.

As previously noted, in configurations, a VRF group 102 represents a group of VRFs 108 that do not have any overlapping subnets. Although, in configurations, subnets are not allowed to overlap between any two VRFs 108 in the same VRF group 102, subnets may definitely overlap between VRFs 108 that are in different VRF groups 102. This technique allows VRFs 108 with overlapping subnets to coexist via different VRF groups 102. However, in some configurations, VRFs 108 may only talk, e.g., leak routes, to other VRFs 108 within the same VRF group 102.

A VRF group 102 may be realized in a cloud site by deploying one or more TGWs 104 per region. In configurations, each TGW 104 may belong to exactly one VRF group 102, e.g., TGWs 104a, 104b may only belong to VRF group 102a, while TGWs 104c, 104d may only belong to VRF group 102b. The VPCs 106 belonging to a given VRF group 102 may be attached to any TGW 104 belonging to that VRF group 102. For example, VPCs 106a-106c may be attached to TGW 104a, while VPCs 106d-106g may be attached to TGW 104b. As will be discussed further herein, VPCs 106 may be attached to more than one TGW 104 within their VRF group 102. VPCs 106/VRFs 108 within a VRF group 102 are able to freely communicate with each other, while VPCs 106 across VRF groups 102 are prohibited from communicating with each other. Thus, VRF groups 102 allow for support of overlapping subnets even when using TGW attachments (VPC attachments) 110, as will be further described herein.

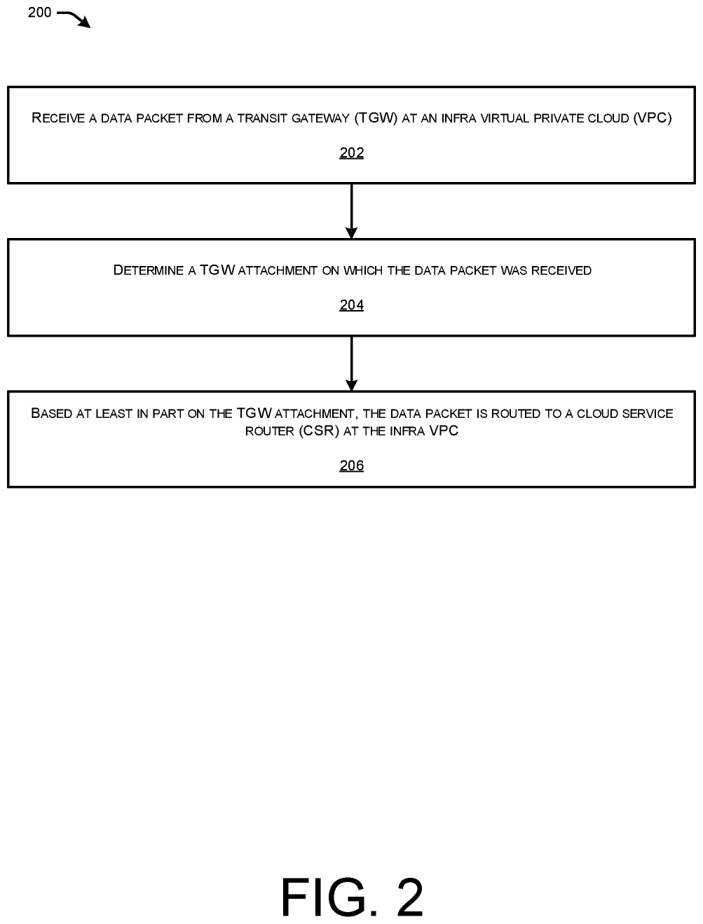

FIG. 1B schematically illustrates an example of a site 112 of a region 114 of a cloud network. In configurations, an infra VPC 116 is attached to all the TGWs 104 in the region 114. This means that there are n-infra VPC-TGW attachments 118, where n is the number of TGWs 104 in the region 114. In the example of FIG. 1B, only two TGWs 104e, 104f are illustrated and thus n equals two. Accordingly, the example of FIG. 1B includes two TGW attachments (also referred to as infra VPC attachments) 118a, 118b. The infra VPC 116 includes one or more CSRs 120. The infra VPC 116 may have multiple CSRs 120 for redundancy and load balancing, as will be further described herein. Thus, the example of FIG. 2 includes two CSRs 120a, 120b.

The infra VPC 116 may be associated to route tables 122a, 122b in each TGW 104e and 104f, respectively, which may be referred to as infra-route tables 122 herein. Routes from route tables 124a, 124b of the VPCs 106m, 106n coupled to the TGWs 104e, 104f are propagated in the TGWs 104e, 104f into the route tables 122a, 122b, respectively.

In configurations, in order to help load balance traffic originating from different TGWs 104 into different CSRs 120, an ingress route table 126 is created in the infra VPC 116 for each TGW 104 in the region 114, e.g., ingress route tables 126a, 126b, respectively. The ingress route tables 126 may be used to direct data packets coming from one of TGWs 104e, 104f based on the corresponding TGW attachments 118a, 118b on which the data packets are received at the infra VPC 116 into one of the CSRs 120a, 120b in the infra VPC 116. Thus, in the example of FIG. 1B, there is one ingress route table 126a for TGW 104e created in the infra VPC 116 and another ingress route table 126b for TGW 104f created in the infra VPC 116. The ingress route table 126a, 126b for each TGW 104e, 104f helps ensure that data packets from TGW 104e are routed to CSR 120a, while data packets from TGW 104f are routed to CSR 120b. This helps achieve load balancing. While only two TGWs 104 and only two CSRs 120 are illustrated in the example of FIG. 1B, there are generally many more TGWs 104 and CSRs 120.

FIG. 1C schematically illustrates the two VRF groups 102a, 102b and the CSR 120a (which is located in the infra VPC 116 that is not illustrated in FIG. 1C for clarity). As previously noted, in configurations VRFs 108 may be segregated into different VRF groups 102, with overlapping subnets supported across different VRF groups 102. Thus, in configurations, there may be two VPCs 106, e.g., VPC 106f and VPC 106h (across the two different VRF groups 102a, 102b) having the same source subnet. Data packets entering, for example, CSR 120a, may thus be identified as belonging to the correct VRF 108 depending on which TGW 104 from which the data packet came and the source IP/subnet of the data packet.

In configurations, in order to identify the VRF 108 of the data packet, a CSR interface 128 is associated to a unique VRF group 102, e.g., data packets entering a given interface 128 of a CSR 120 may only come from TGWs 104 belonging to that VRF group 102. A policy-based routing (PBR) rule is installed on the CSR's network interface for example, 128a, with the IP based match rule to identify the VRF 108 of the data packet within that VRF group 102. For example, VRF 108f belongs to VRF group 102a, and VRF 108h belongs to VRF group 102b. Assume that both of the VRFs 108f, 108h contain overlapping subnet 10.0.0.0/16. Also assume that interface 128a of the CSR 120a is picked for VRF group 102a and interface 128b of the CSR 116a is picked for VRF group 102b. This will need two PBR entries in the CSR 120a as follows:
route-map vrflRMap permit 10
   match ip address 10.0.0.0/16→10.0/16 maps to vrf108f in VrfGroup102a set vrf vrf108a
interface 128a→Packets from VRFGroup102a TGWs will enter this internal face, based on ingress subnet route-table entry
   ip policy route-map vrf108fRMap
********
route-map vrf2RMap permit 10
   match ip address 10.0.0.0/16→10.0/16 maps to vrf108h in VrfGroup102b set vrf vrf102b
interface 128b→Packets from VRFGroup102b TGWs will enter this internal face, based on ingress subnet route-table entry
ip policy route-map vrf108hRMap

Thus, two VRF entries in the CSR 120a need to be provided to dynamically map 10.0.0.0/16 subnet into VRF 108f or VRF 108h based on the ingress interface at the CSR 120a, thereby supporting overlapping subnets by placing VRF 108f and VRF 108h in different VRF groups 102, e.g., VRF groups 102a and 102b, respectively.

In configurations, redundancy and load balancing may be achieved within a VRF group 102 without the need for BGP and ECMP. Without data path ECMP, a manner in which to load balance traffic to and from the VPCs 108 (via the CSRs 120 for external connectivity) is needed. In one configuration, source-based spraying may be used. Such source-based spraying may provide that traffic originating from different VPCs 108 be routed to different CSRs 120. However, all traffic from a given VPC 108 may always be pinned to a single CSR 120 (e.g., CSR 120a via TGW 104a) and hence may never hit any other CSR 120 in the infra VPC 116. Thus, in configurations, when the VPCs 106a-1061 are created, the VPCs 106a-1061 may be attached to one of TGWs 104a, 104b, 104c, 104d in a VRF group 102a, 102b in their region, e.g., region 114, in a round robin fashion. This allows the traffic to be load balanced across TGWs 104 in the region 114.

FIG. 1D schematically illustrates VRF groups 102a, 120b with TGWs 104a-104d, and infra VPC 116 with CSRs 120a, 120b (the VPCs 106 are omitted for clarity). In configurations, each TGW 104 may also be mapped to a CSR 120 virtual machine (VM) instance in the infra VPC 116 via a corresponding TGW attachment 118. For every TGW 104 attached to the infra VPC 116, there is an ingress route table 126 entry that forwards all the traffic received from that TGW 104 to a particular interface 128 on a CSR 120. In the example of FIG. 1D, there are four TGWs 104a-104d and thus, there are four route tables 126a-126d corresponding to the four TGWs 104a-104d, respectively. Such a technique translates to each VRF group 102 being mapped to exactly one interface 128 on each CSR 120 in the region 114. For example, as may be seen in FIG. 1D, TGW 104a is mapped to interface 128a of CSR 120a, while TGW 104b is mapped to interface 128a of CSR 120b. TGW 104c is mapped to interface 128b of CSR 120a, while TGW 104d is mapped to interface 128b of CSR 120b. Thus, VRF group 102a may be mapped to interface(s) 128a of the CSRs 120a, 120b (as well as any other CSRs 120 that may be included in the infra VPC 116 but not illustrated), while VRF group 102b may be mapped to interface(s) 128b of the CSRs 120a, 120b (as well as any other CSRs 120 that may be included in the infra VPC 116 but not illustrated).

As new VRF groups 102 are added, another interface 128 on the CSR 120 may be provisioned to receive traffic from the VPCs 106 of the new VRF groups 102. Consequently, the number of interfaces 128 on the CSRs 120 determines the number of VRF groups 102 that the architecture may support. To scale beyond the number of supported VRF groups 102, it may be desirable to deploy more CSR interfaces 128 or create new CSRs 120 to support newer VRF groups 102. Additionally, if a CSR 120 were to go down, just by changing the corresponding ingress route table 126 entry for the corresponding TGW attachment(s) 118 between the infra VPC 116 and TGWs 104, the traffic may be routed to a corresponding interface on another CSR 120, thereby minimizing traffic loss.

FIG. 1E schematically illustrates the VPCs 106a and 106b of VRF group 102a and the CSRs 120a, 120b in the infra VPC 116. In configurations, destination-based spraying may be utilized where the VPCs 106, e.g., VPCs 106a and 106b, attach to two or more different TGWs 104, e.g., TGWs 104a, 104b. The TGWs 104a, 104b may be mapped to different CSRs 120a, 120b. Thus, in order to spray the traffic between the two CSRs 120a, 120b, the traffic out of the VPCs 106a and 106b needs to be load balanced across the two TGWs 104a, 104b to which the VPCs 106a and 106b are attached. This may be achieved by using the corresponding route tables 124a, 124b in the VPCs 106a and 106b to direct the traffic to TGW 104a or TGW 104b based on the destination, e.g., destination-based load balancing. For example, a hash may be used in the next hop portion of the route tables 124 to alternate directing traffic from the VPCs 106a and 106b to the TGWs 104a and 104b. The destination-based spraying may also be utilized for the other VPCs 106c-106f of VRF group 102a and the VPCs 106g-1061 of the VRF group 102b.

Thus, the techniques and architecture described herein provide VRF Groups that group VPCs that do not have overlapping subnets. This allows support for overlapping subnets without using VPN/IPSec tunnels, which native cloud deployments currently cannot support. Additionally, the number of VRF Groups supported may be elastically scaled by either increasing the interfaces on the CSR or by increasing the number of CSRs. Also, the bandwidth limitations of using VPN tunnel attachments (e.g., 1.25 Gb per VPN) by using TGW attachments (also known as VPC attachments) to infra VPCs (where the CSRs reside). By doing this, the full bandwidth of a TGW may be accessed which provides 50 Gb instead of 1.25 Gb per VPN connection. Furthermore, additional data packets routes are achieved by using TGW attachments, which does not require BGP.

FIG. 2 illustrates a flow diagram of an example method 200 and illustrates aspects of the functions performed at least partly by one or more devices in the multi-cloud fabric 100 as described in FIGS. 1A-1E. The logical operations described herein with respect to FIG. 2 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 2 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by less components, more components, different components, or any configuration of components.

FIG. 2 illustrates a flow diagram of an example method 200 for routing data packets through service chains within public cloud networks of multi-cloud fabrics. In some examples, the method 200 may be performed by a system comprising one or more processors and one or more non-transitory computer-readable media storing computer-executable instructions that, when executed by the one or more processors, cause the one or more processors to perform the method 200. At 202, a data packet is received from a transit gateway (TGW) at an infra virtual private cloud (VPC). For example, a data packet may be received from TGW 104a at infra VPC 116. At 204, a TGW attachment on which the data packet was received is determined. For example, it may be determined that the data packet arrived on TGW attachment 118a, thereby indicating that the data packet came from TGW 104a. At 206, based at least in part on the TGW attachment, the data packet is routed to a cloud service router (CSR) at the infra VPC. For example, based at least in part on the data packet arriving on TGW attachment 118a, the data packet may be directed to the CSR 120a.

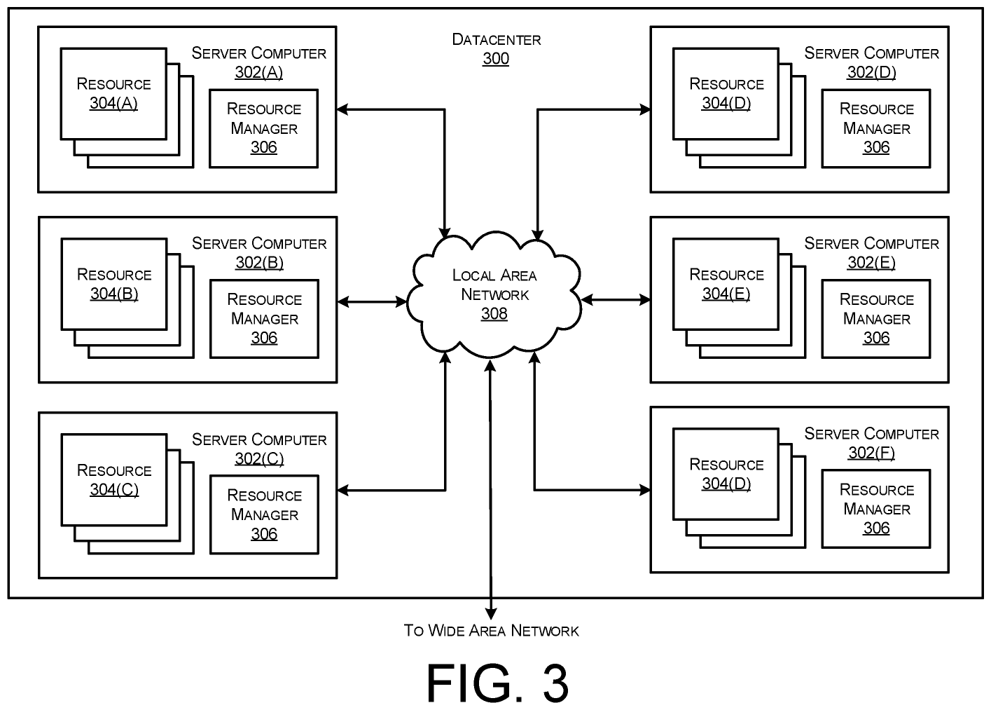

FIG. 3 is a computing system diagram illustrating a configuration for a datacenter 300 that can be utilized to implement aspects of the technologies disclosed herein. The example datacenter 300 shown in FIG. 3 includes several server computers 302A-302F (which might be referred to herein singularly as “a server computer 302” or in the plural as “the server computers 302”) for providing computing resources. In some examples, the resources and/or server computers 302 may include, or correspond to, the VPCs 106 described herein.

The server computers 302 can be standard tower, rack-mount, or blade server computers configured appropriately for providing the computing resources described herein. As mentioned above, the computing resources provided by the cloud computing networks can be data processing resources such as VM instances or hardware computing systems, database clusters, computing clusters, storage clusters, data storage resources, database resources, networking resources, and others. Some of the servers 302 can also be configured to execute a resource manager capable of instantiating and/or managing the computing resources. In the case of VM instances, for example, the resource manager can be a hypervisor or another type of program configured to enable the execution of multiple VM instances on a single server computer 302. Server computers 302 in the datacenter 300 can also be configured to provide network services and other types of services.

In the example datacenter 300 shown in FIG. 3, an appropriate LAN 308 is also utilized to interconnect the server computers 302A-302F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between datacenters 300, between each of the server computers 302A-302F in each datacenter 300, and potentially between computing resources in each of the server computers 302. It should be appreciated that the configuration of the datacenter 300 described with reference to FIG. 3 is merely illustrative and that other implementations can be utilized.

In some examples, the server computers 302 may each execute one or more virtual resources that support a service or application provisioned across a set or cluster of servers 302. The virtual resources on each server computer 302 may support a single application or service, or multiple applications or services (for one or more users).

In some instances, cloud computing networks may provide computing resources, like application containers, VM instances, and storage, on a permanent or an as-needed basis. Among other types of functionality, the computing resources provided by cloud computing networks may be utilized to implement the various services described above. The computing resources provided by the cloud computing networks can include various types of computing resources, such as data processing resources like application containers and VM instances, data storage resources, networking resources, data communication resources, network services, and the like.

Each type of computing resource provided by the cloud computing networks can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing networks can also be configured to provide other types of computing resources not mentioned specifically herein.

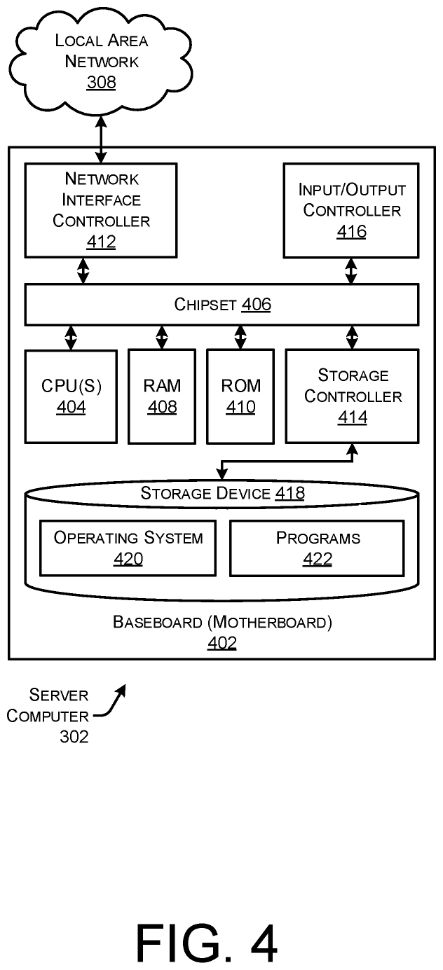

The computing resources provided by the cloud computing networks may be enabled in one embodiment by one or more datacenters 300 (which might be referred to herein singularly as “a datacenter 300” or in the plural as “the datacenters 300”). The datacenters 300 are facilities utilized to house and operate computer systems and associated components. The datacenters 300 typically include redundant and backup power, communications, cooling, and security systems. The datacenters 300 can also be located in geographically disparate locations. One illustrative embodiment for a datacenter 300 that can be utilized to implement the technologies disclosed herein will be described below with regard to FIG. 4.

FIG. 4 shows an example computer architecture for a server computer 302 capable of executing program components for implementing the functionality described above. The computer architecture shown in FIG. 4 illustrates a conventional server computer, workstation, desktop computer, laptop, tablet, network appliance, e-reader, smartphone, or other computing device, and can be utilized to execute any of the software components presented herein. The server computer 302 may, in some examples, correspond to physical devices or resources described herein.

The server computer 302 includes a baseboard 402, or “motherboard,” which is a printed circuit board to which a multitude of components or devices can be connected by way of a system bus or other electrical communication paths. In one illustrative configuration, one or more central processing units (“CPUs”) 404 operate in conjunction with a chipset 406. The CPUs 404 can be standard programmable processors that perform arithmetic and logical operations necessary for the operation of the server computer 302.

The CPUs 404 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 406 provides an interface between the CPUs 404 and the remainder of the components and devices on the baseboard 402. The chipset 406 can provide an interface to a RAM 408, used as the main memory in the server computer 302. The chipset 406 can further provide an interface to a computer-readable storage medium such as a read-only memory (“ROM”) 410 or non-volatile RAM (“NVRAM”) for storing basic routines that help to startup the server computer 302 and to transfer information between the various components and devices. The ROM 410 or NVRAM can also store other software components necessary for the operation of the server computer 302 in accordance with the configurations described herein.

The server computer 302 can operate in a networked environment using logical connections to remote computing devices and computer systems through a network, such as the LAN 308. The chipset 406 can include functionality for providing network connectivity through a NIC 412, such as a gigabit Ethernet adapter. The NIC 412 is capable of connecting the server computer 302 to other computing devices over the LAN 308. It should be appreciated that multiple NICs 412 can be present in the server computer 302, connecting the computer to other types of networks and remote computer systems.

The server computer 302 can be connected to a storage device 418 that provides non-volatile storage for the computer. The storage device 418 can store an operating system 420, programs 422, and data, which have been described in greater detail herein. The storage device 418 can be connected to the server computer 302 through a storage controller 414 connected to the chipset 406. The storage device 418 can consist of one or more physical storage units. The storage controller 414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server computer 302 can store data on the storage device 418 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 418 is characterized as primary or secondary storage, and the like.

For example, the server computer 302 can store information to the storage device 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server computer 302 can further read information from the storage device 418 by detecting the physical states or characteristics of one or more particular locations within the physical storage units.

In addition to the storage device 418 described above, the server computer 302 can have access to other computer-readable storage media to store and retrieve information, such as program modules, data structures, or other data. It should be appreciated by those skilled in the art that computer-readable storage media is any available media that provides for the non-transitory storage of data and that can be accessed by the server computer 302. In some examples, the operations performed by the cloud computing network, and or any components included therein, may be supported by one or more devices similar to server computer 302. Stated otherwise, some or all of the operations performed by cloud computing networks, and or any components included therein, may be performed by one or more computer devices 302 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 418 can store an operating system 420 utilized to control the operation of the server computer 302. According to one embodiment, the operating system comprises the LINUX operating system. According to another embodiment, the operating system comprises the WINDOWS® SERVER operating system from MICROSOFT Corporation of Redmond, Wash. According to further embodiments, the operating system can comprise the UNIX operating system or one of its variants. It should be appreciated that other operating systems can also be utilized. The storage device 418 can store other system or application programs and data utilized by the server computer 302.

In one embodiment, the storage device 418 or other computer-readable storage media is encoded with computer-executable instructions which, when loaded into the server computer 302, transform the computer from a general-purpose computing system into a special-purpose computer capable of implementing the embodiments described herein. These computer-executable instructions transform the server computer 302 by specifying how the CPUs 404 transition between states, as described above. According to one embodiment, the server computer 302 has access to computer-readable storage media storing computer-executable instructions which, when executed by the server computer 302, perform the various processes described above with regard to FIGS. 1-2. The server computer 302 can also include computer-readable storage media having instructions stored thereupon for performing any of the other computer-implemented operations described herein.

The server computer 302 can also include one or more input/output controllers 416 for receiving and processing input from a number of input devices, such as a keyboard, a mouse, a touchpad, a touch screen, an electronic stylus, or other type of input device. Similarly, an input/output controller 416 can provide output to a display, such as a computer monitor, a flat-panel display, a digital projector, a printer, or other type of output device. It will be appreciated that the server computer 302 might not include all of the components shown in FIG. 4, can include other components that are not explicitly shown in FIG. 4, or might utilize an architecture completely different than that shown in FIG. 4.

The server computer 302 may support a virtualization layer, such as one or more virtual resources executing on the server computer 302. In some examples, the virtualization layer may be supported by a hypervisor that provides one or more virtual machines running on the server computer 302 to perform functions described herein. The virtualization layer may generally support a virtual resource that performs at least portions of the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving a data packet from a transit gateway (TGW) at an infra virtual private cloud (VPC);
determining a TGW attachment on which the data packet was received; and
based at least in part on the TGW attachment, routing the data packet to a cloud service router (CSR) at the infra VPC.

2. The method of claim 1, wherein routing the data packet to the CSR comprises:
based at least in part on the TGW attachment, determining an interface of the CSR to which to route the data packet; and
routing the data packet to the interface of the CSR.

3. The method of claim 2, wherein (i) the data packet is a first data packet, (ii) the TGW is a first TGW, and (iii) the TGW attachment is a first TGW attachment, the method further comprising:
receiving a second data packet from a second TGW at the infra VPC;
determining a second TGW attachment on which the second data packet was received; and
based at least in part on the second TGW attachment, routing the second data packet to the CSR at the infra VPC.

4. The method of claim 3, wherein the interface is a first interface, the method further comprising:
based at least in part on the second TGW attachment, determining a second interface of the CSR to which to route the second data packet; and
routing the second data packet to the second interface of the CSR.

5. The method of claim 4, wherein the first interface and the second interface are the same interface.

6. The method of claim 4, wherein the first interface and the second interface are different interfaces.

7. The method of claim 1, wherein (i) the data packet is a first data packet, (ii) the TGW is a first TGW, (iii) the TGW attachment is a first TGW attachment, and (iv) the CSR is a first CSR, the method further comprising:
receiving a second data packet from a second TGW at the infra VPC;
determining a second TGW attachment on which the second data packet was received; and
based at least in part on the second TGW attachment, routing the second data packet to a second CSR at the infra VPC.

8. The method of claim 7, further comprising:
based at least in part on the first TGW attachment, determining a first interface of the first CSR to which to route the data packet;
routing the first data packet to the first interface of the first CSR;
based at least in part on the second TGW attachment, determining a second interface of the second CSR to which to route the second data packet; and
routing the second data packet to the second interface of the second CSR.

9. The method of claim 8, wherein the second interface at the second CSR corresponds to the first interface at the first CSR.

10. The method of claim 9, wherein the VPC is attached to both the first TGW and the second TGW.

11. The method of claim 7, wherein the VPC is a first VPC attached to only the first TGW and a second VPC is only attached to the second TGW.

12. A system comprising:
one or more processors; and
one or more non-transitory computer-readable media storing computer-executable instructions that, when executed by the one or more processors, cause the one or more processors to perform actions comprising:
receiving a data packet from a transit gateway (TGW) at an infra virtual private cloud (VPC);
determining a TGW attachment on which the data packet was received; and
based at least in part on the TGW attachment, routing the data packet to a cloud service router (CSR) at the infra VPC.

13. The system of claim 12, wherein routing the data packet to the CSR comprises:
based at least in part on the TGW attachment, determining an interface of the CSR to which to route the data packet; and
routing the data packet to the interface of the CSR.

14. The system of claim 13, wherein (i) the data packet is a first data packet, (ii) the TGW is a first TGW, and (iii) the TGW attachment is a first TGW attachment, the actions further comprising:
receiving a second data packet from a second TGW at the infra VPC;
determining a second TGW attachment on which the second data packet was received; and
based at least in part on the second TGW attachment, routing the second data packet to the CSR at the infra VPC.

15. The system of claim 14, wherein the interface is a first interface, the actions further comprising:
based at least in part on the second TGW attachment, determining a second interface of the CSR to which to route the second data packet; and
routing the second data packet to the second interface of the CSR.

16. The system of claim 12, wherein (i) the data packet is a first data packet, (ii) the TGW is a first TGW, (iii) the TGW attachment is a first TGW attachment, and (iv) the CSR is a first CSR, the actions further comprising:
receiving a second data packet from a second TGW at the infra VPC;
determining a second TGW attachment on which the second data packet was received; and
based at least in part on the second TGW attachment, routing the second data packet to a second CSR at the infra VPC.

17. The system of claim 16, the actions further comprising:
based at least in part on the first TGW attachment, determining a first interface of the first CSR to which to route the data packet;
routing the first data packet to the first interface of the first CSR;
based at least in part on the second TGW attachment, determining a second interface of the second CSR to which to route the second data packet; and
routing the second data packet to the second interface of the second CSR.

18. The system of claim 16, wherein the VPC is a first VPC attached to only the first TGW and a second VPC is only attached to the second TGW.

19. One or more non-transitory computer-readable media storing computer-executable instructions that, when executed by one or more processors, cause the one or more processors to perform actions comprising:
receiving a data packet from a transit gateway (TGW) at an infra virtual private cloud (VPC);
determining a TGW attachment on which the data packet was received; and
based at least in part on the TGW attachment, routing the data packet to a cloud service router (CSR) at the infra VPC.

20. The one or more non-transitory computer-readable media of claim 19, wherein routing the data packet to the CSR comprises:
based at least in part on the TGW attachment, determining an interface of the CSR to which to route the data packet; and
routing the data packet to the interface of the CSR.
